(19) United States
(12) Patent Application Publication
(10) Pub. No.: US 2020/0201225 A1
(43) Pub. Date: Jun. 25, 2020

(54) IMAGE FORMING APPARATUS

(71) Applicant: CANON KABUSHIKI KAISHA, Tokyo (JP)

(72) Inventor: Takeshi Sekiya, Kashiwa-shi (JP)

(21) Appl. No.: 16/716,273

(22) Filed: Dec. 16, 2019

(30) Foreign Application Priority Data
Dec. 20, 2018 (JP) 2018-238648

(51) Int. Cl. G03G 15/00; G03G 15/16

(52) U.S. Cl. CPC G03G 15/5054; G03G 15/1605

(57) ABSTRACT

An image forming apparatus comprises: an image forming unit for forming an image; a transfer member onto which the image is to be transferred; a transfer unit for transferring the image formed on the transfer member onto a sheet; a sensor for detecting reflected light from a detection image on the transfer member based on a detection condition; and a controller that controls the sensor to detect an area of the transfer member in which the image is not formed, generates the detection condition based on the result of detection of the area, controls the sensor to detect the detection image based on the detection condition, and controls a density of an image to be formed by the image forming unit, based on the result of detection of the detection image.

### BACKGROUND OF THE INVENTION

### Field of the Invention

The aspect of the embodiments relates to an image forming apparatus that has a sensor for detecting an image to be detected formed on a transfer member, and controls detection conditions for the sensor.

### Description of the Related Art

Conventionally, an image forming apparatus that employs an electrophotographic method corrects the density of an image by forming a plurality of density correction toner images (toner patches) on an image carrier such as a photosensitive drum or a transfer member, detecting the toner patches using an optical sensor, and creating correction data.

Some image forming apparatuses that form color images are known as tandem type image forming apparatuses that have a photosensitive drum for each of the color components of color images, and combine toner images of the respective color components, using a transfer member. Through a density correction operation performed by a tandem type image forming apparatus, a plurality of toner patches for density correction, transferred onto a transfer member, are scanned using an optical sensor, the densities of the scanned toner patches are obtained, and image forming conditions for each color component are appropriately adjusted based on the result of obtainment. There are also known image forming apparatuses that are configured to be able to shorten the time required to complete the above-described density correction operation by performing parallel operations using a plurality of optical sensors that are provided in a horizontal scanning direction (see Japanese Patent Laid-Open No. 2006-139179).

However, the color of the surface of the transfer member may change due to deterioration with time. In such a case, detection values obtained as a result of the optical sensors detecting color toner patches transferred onto the transfer member may vary even if toner patches of the same density are formed. If this is the case, even if the density correction operation is performed using the detected values, the density cannot be optimized, and the image forming operation cannot be performed using correct densities.

### SUMMARY OF THE INVENTION

According to one aspect of the embodiments, there is provided an image forming apparatus that forms an image on a sheet, comprising: an image forming unit configured to form the image; a transfer member onto which the image is to be transferred; a transfer unit configured to transfer the image formed on the transfer member onto the sheet; a sensor configured to detect reflected light from a detection image on the transfer member based on a detection condition; and a controller configured to: control the sensor to detect an area of the transfer member in which the image is not formed; generate the detection condition based on the result of detection of the area; control the sensor to detect the detection image based on the detection condition; and control a density of an image to be formed by the image forming unit, based on the result of detection of the detection image.

Further features of the disclosure will become apparent from the following description of exemplary embodiments (with reference to the attached drawings).

### BRIEF DESCRIPTION OF THE DRAWINGS

FIG. 1 is a diagram showing an example of an overall configuration of an image forming apparatus according to the aspect of the embodiments.

FIG. 2 is a diagram showing an example of a configuration of a control unit of the image forming apparatus according to the aspect of the embodiments.

FIG. 3 is a cross-sectional view showing a portion of an intermediate transfer unit according to the aspect of the embodiments.

FIG. 4 is a perspective view showing the intermediate transfer unit and the surroundings thereof according to the aspect of the embodiments.

FIG. 5 is a diagram showing an example of an internal configuration of a density detection sensor according to the aspect of the embodiments.

FIGS. 6A and 6B are diagrams illustrating a density table according to the aspect of the embodiments.

FIG. 7 is a diagram illustrating a relationship between the color of an intermediate transfer belt and a sensor detection value.

FIG. 8 is a diagram showing examples of reference patches that are used to perform a density correction operation according to a first embodiment.

FIG. 9 is a flowchart of the density correction operation according to the embodiment.

FIG. 10 is a diagram showing an example of a table for charge accumulation time according to the embodiment.

FIG. 11 is a diagram showing examples of reference patches that are used to perform a density correction operation according to a second embodiment.

### DESCRIPTION OF THE EMBODIMENTS

The following describes the aspect of the embodiments in detail with reference to the drawings. Note that the embodiments shown below are examples, and the disclosure is not intended to be limited to the embodiments.

### First Embodiment

### Image Forming Apparatus

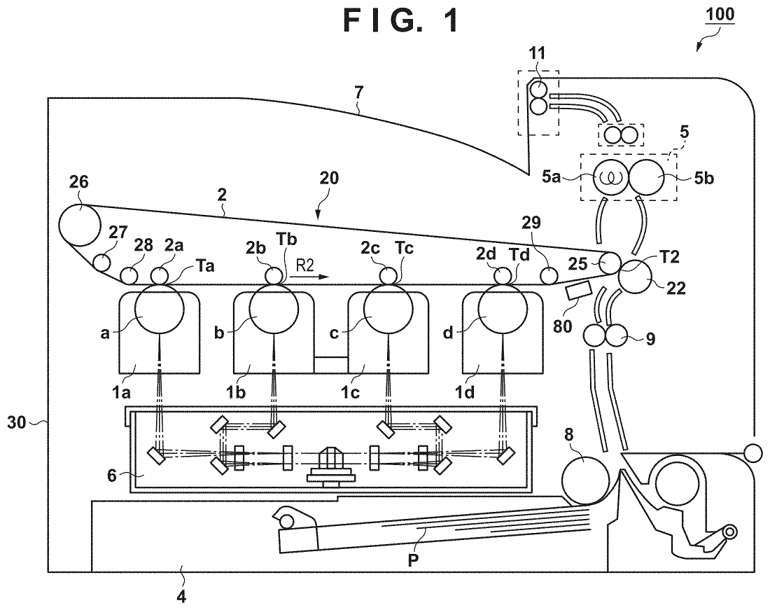

FIG. 1 is a diagram showing an example of an overall configuration of an image forming apparatus according to the aspect of the embodiments. As shown in FIG. 1, an image forming apparatus 100 is a tandem type full color printer employing an intermediate transfer method, in which four image forming units 1a, 1b, 1c, and 1d are arranged along a surface that faces downward, of an intermediate transfer belt 2. A separation roller 8 separates recording materials P, drawn out of a recording material cassette 4, from one another, and sends out a recording material P to a registration roller 9. The registration roller 9 in a stopped state receives and holds the recording material P, and feeds the recording material P to a secondary transfer portion T2 in appropriate timing for a toner image on the intermediate transfer belt 2, which functions as an image carrier.

The image forming units 1a, 1b, 1c, and 1d have substantially the same configuration except that the colors of toner used in their respective developing devices are different from each other, which are yellow, magenta, cyan, and black. The following describes the image forming unit 1a, and descriptions of the other image forming units 1b, 1c, and 1d can be provided when “a” at the end of the reference numerals in this description is replaced with b, c, and d. The image forming unit 1a is assembled as a replacement unit (a processing cartridge) that includes a photosensitive drum a. The photosensitive drum a has a photosensitive layer of negative charge polarity on the outer circumferential surface of an aluminum cylinder thereof, and receives a driving force from a drive motor (not shown) to rotate at a predetermined processing speed. The photosensitive drum a is uniformly charged to a negative potential, using a charging roller (not shown) that is built into the image forming unit 1a.

An exposure device 6 performs scanning with a laser beam obtained by performing ON-OFF modulation on scan line image data developed from a yellow separation color image, using a rotating mirror (not shown), to write an electrostatic image on the surface of the charged photosensitive drum a. The developing device (not shown) built into the image forming unit 1a applies toner to the electrostatic image written on the photosensitive drum a, and reversal development is performed so that a toner image is formed.

A primary transfer roller 2a presses the intermediate transfer belt 2 to form a primary transfer portion Ta between the photosensitive drum a and the intermediate transfer belt 2. As a result of a positive DC voltage being applied to the primary transfer roller 2a, the toner image of negative polarity carried by the photosensitive drum a is subjected to primary transfer onto the intermediate transfer belt 2 that passes past the primary transfer portion Ta.

An intermediate transfer unit 20 is provided above the image forming units 1a to 1d, and is a replaceable unit that can be entirely detached without detaching any component related to rotational drive, from the image forming apparatus 100. The intermediate transfer unit 20 includes a supporting mechanism and a drive mechanism for the intermediate transfer belt 2.

The intermediate transfer belt 2, which is an example of a belt member, is routed around, and supported by, a tension roller 27, a drive roller 26, a secondary transfer tension roller 25, and primary transfer tension rollers 28 and 29, and is driven by the drive roller 26 to rotate in the direction indicated by an arrow R2. The intermediate transfer belt 2 is an endless belt member that does not expand or contract, and is routed between the drive roller 26 and the secondary transfer tension roller 25 such that the direction of rotation can be reversed. The intermediate transfer unit 20 also includes a density detection sensor 80 that detects the density of a toner image on the intermediate transfer belt 2.

Primary transfer rollers 2a, 2b, 2c, and 2d are built into the intermediate transfer unit 20 in correspondence with the image forming unit 1a, 1b, 1c, and 1d. The primary transfer rollers 2a to 2d are biased toward the photosensitive drums a, b, c, and d, using springs, and thus the intermediate transfer belt 2 is abutted against the photosensitive drums a, b, c, and d, and primary transfer portions for transferring toner images are formed.

The secondary transfer portion T2 is formed by abutting a secondary transfer roller 22 against the intermediate transfer belt 2 whose inner surface is tensioned by the secondary transfer tension roller 25. The secondary transfer tension roller 25 is built into the intermediate transfer unit 20, whereas the secondary transfer roller 22 is built into a main body 30 of the image forming apparatus 100. The intermediate transfer belt 2 is supported by the secondary transfer tension roller 25 in a tensioned state at the secondary transfer portion T2 for transferring a toner image. As a result of a positive DC voltage being applied from a power supply (not shown) to the secondary transfer roller 22, a transfer field for transferring a toner image is formed between the secondary transfer roller 22 and the secondary transfer tension roller 25 that is connected to a ground potential.

A fixing unit 5 presses a pressure roller 5b against a fixing roller 5a that is provided with a heater, thereby forming a heating nip. A toner image is fused due to heat and pressure applied thereto while the recording material P is conveyed through the heating nip in a sandwiched state, and a full color image is fixed to the surface of the recording material P. A discharge roller 11 discharges the recording material P, on which the toner image is fixed to the surface thereof due to heat and pressure applied by the fixing unit 5, to a discharge tray 7.

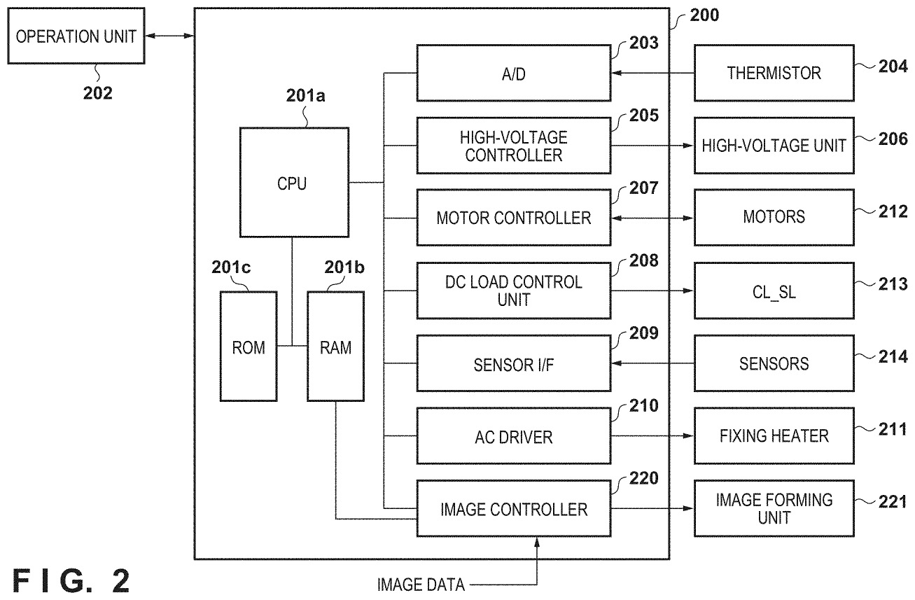

Next, operations of the image forming apparatus 100 will be described. A control unit includes: a CPU (Central Processing Unit) for controlling operations of mechanisms included in each of the above-described units; a motor driver unit; and so on. Details will be described later with reference to FIG. 2 and so on.

Upon a start signal for starting an image forming operation being transmitted from the CPU, a paper feed operation is started in order to feed paper from a selected paper source according to a selected paper size and so on. First, the separation roller 8 sends out the recording materials P one by one from the recording material cassette 4, and each recording material P is conveyed to the registration roller 9. At this time, the registration roller 9 has been stopped, and the leading end of the recording material P comes into contact with a nip that is formed by the registration roller 9. Thereafter, the registration roller 9 starts rotating so as to synchronize with the start of image formation that is to be performed by the image forming units 1a to 1d. The timing of the start of rotation is set such that the recording material P and the toner images subjected to primary transfer onto the intermediate transfer belt 2 performed by the image forming units 1a to 1d reach the secondary transfer portion T2 at the same time.

On the other hand, regarding the image forming units 1a to 1d, upon a start signal for starting an image forming operation being transmitted, a toner image formed on the photosensitive drum a, which is located the most upstream in the direction of rotation of the intermediate transfer belt 2, is subjected to primary transfer onto the intermediate transfer belt 2, within a primary transfer area Ta, through the above-described process. The toner image subjected to primary transfer is conveyed to the next primary transfer area, Tb. In the primary transfer area Tb, image formation is performed with a delay corresponding to the time required to convey a toner image. Registration is performed on the previous image and the subsequent toner image is transferred thereonto. The same process is repeatedly performed, and, as a result, a four-color toner image is primary-transferred onto the intermediate transfer belt 2.

Thereafter, upon the recording material P entering the secondary transfer portion T2 and coming into contact with the intermediate transfer belt 2, a high voltage is applied to the secondary transfer roller 22 in appropriate timing corresponding to the time at which the recording material P passes therethrough. As a result, the four-color toner image formed on the intermediate transfer belt 2 through the above-described process is transferred to the surface of the recording material P. Thereafter, the recording material P is accurately guided to the nip of the fixing unit 5.

In the fixing unit 5, the recording material P is conveyed in a sandwiched state, and the toner image is fixed onto the surface of the recording material P due to heat and pressure while the recording material P is conveyed. The recording materials P that have passed through the fixing unit 5 are conveyed by the discharge roller 11, and are discharged to, and stacked on, the discharge tray 7.

Control Unit

Next, FIG. 2 shows an example of a configuration of a control unit included in the image forming apparatus 100. The image forming apparatus 100 according to the present embodiment is totally controlled by a control unit 200. The control unit 200 serves to drive each load in the image forming apparatus 100, collect/analyze information regarding sensors or the like, perform image control, and exchange data with an operation unit 202, i.e. a user interface. Regarding the internal configuration, the control unit 200 includes a CPU 201a in order to perform the above-described functions. The CPU 201a executes various sequences related to a predetermined image formation sequence according to programs stored in a ROM 201c included in the control unit 200. The control unit 200 also includes a RAM 201b in order to store rewritable data that is to be temporarily or permanently stored. The RAM 201b stores, for example, a high-voltage setting value that is to be set to a high-voltage controller 205, various kinds of data described below, image formation instruction information received from the operation unit 202, and so on. The RAM 201b is configured to keep storing data, using a battery (not shown) or the like, even after the image forming apparatus has been powered off.

The control unit 200 acquires information such as a magnification ratio for copying, a density setting value, and so on set by the user via the operation unit 202. Also, the control unit 200 transmits, to the operation unit 202, data for notifying the user of the state of the image forming apparatus 100, e.g. the number of sheets on which image formation is to be performed, information indicating whether or not the image forming apparatus 100 is performing image formation, the occurrence of a jam, and the position of the jam.

In the image forming apparatus 100, a motor, DC loads such as a clutch/solenoid, and sensors such as a photo interrupter and a micro switch are provided at their respective positions. That is to say, the conveyance of recording materials P and the driving of each unit as shown in FIG. 1 is realized by appropriately driving the motor and each DC load, and the operations thereof are monitored by the sensors.

Based on signals from sensors 214, the control unit 200 causes a motor controller 207 to control motors 212, and simultaneously causes a DC load controller 208 to operate the clutch/solenoid 213 to smoothly perform an image forming operation. Also, the control unit 200 transmits various high-voltage control signals from the high-voltage controller 205 to a high-voltage unit 206. The high-voltage unit 206 applies an appropriate high voltage to various chargers, namely a primary charger, a transfer charger, and a development roller included in a developer, based on signals from the control unit 200. Furthermore, a fixing heater 211 for heating a roller is built into a fixing roller 5b, and the fixing heater 211 is subjected to ON/OFF control performed by an AC driver 210. Each fixing roller is provided with a thermistor 204 for measuring the temperature thereof. An A/D 203 converts a change in the resistance value of the thermistor 204 corresponding to a change in the temperature of each fixing roller to a voltage value, which is input to the control unit 200 as a digital value. The above-described AC driver 210 is controlled based on this temperature data.

Also, an image controller 220 processes image data input from the outside, and image data thus processed is input to each of the image forming units 1a to 1d.

Intermediate Transfer Unit

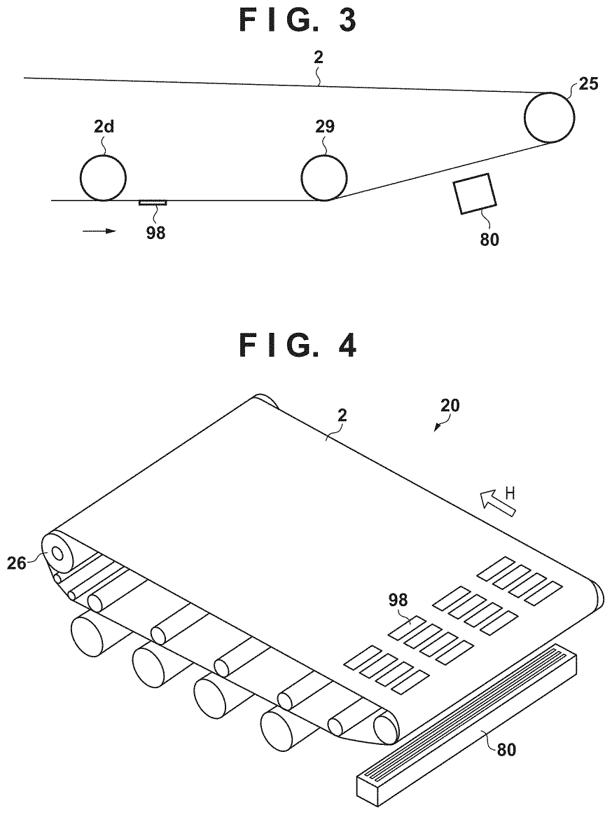

FIG. 3 is a cross-sectional view showing a portion of the intermediate transfer unit 20 according to the present embodiment. Through a density correction operation, toner images are formed on the intermediate transfer belt 2 as reference patches 98, and the densities of the reference patches 98 are detected by the density detection sensor 80. In the present embodiment, the density detection sensor 80 is a color image sensor, which emits light to the toner image on the intermediate transfer belt 2 and detects the reflected light. Based on the densities detected from the above-described reference patches 98, the CPU 201a corrects a density table (LUT: Look Up Table) stored in the RAM 201b and reflects the result to the image processing operation. The CPU 201a performs image processing through which conversion is performed on signal values of the image data based on the density table. This is image processing that is performed to correct the density characteristic (tone characteristic) of an image that is to be formed by the image forming apparatus 100, to be an ideal density characteristic. Here, the density table (LUT) provides conversion conditions that are to be applied when conversion is performed on the image data.

FIG. 4 is a perspective view showing the intermediate transfer unit 20 and the surroundings thereof according to the present embodiment. As shown in FIG. 4, in the intermediate transfer unit 20, the drive roller 26 causes a drive motor (not shown) to rotate the intermediate transfer belt 2 in the direction indicated by an arrow H in the figure. The density detection sensor 80, which is a line-shaped color image sensor, is provided below the intermediate transfer unit 20 so as to extend in the horizontal scanning direction (the width direction). As shown in FIG. 4, the horizontal scanning direction, in which the density detection sensor 80 extends, is orthogonal to the direction indicated by the arrow H, in which the intermediate transfer belt 2 is conveyed. In the present embodiment, the width within which the density detection sensor 80 can perform detection is longer than, or substantially equal to, the width within which the intermediate transfer unit 20 performs image formation.

When a density correction operation is to be performed, reference patch images of the respective colors formed by the image forming units 1a to 1d are transferred onto the intermediate transfer belt 2 within the primary transfer areas Ta to Td at predetermined timings Thereafter, the density detection sensor 80 reads the reference patch images formed on the intermediate transfer belt 2. n reference patches 98 (n is a positive integer) with different densities are formed for each toner color. By using a line sensor provided in the width direction of the intermediate transfer belt 2 as the density detection sensor 80, it is possible to read a plurality of density patches at the same time, and it is possible to shorten the time required to perform a correction operation.

The surface of the intermediate transfer belt 2 is white or a predetermined bright color, which is defined by a numeric value in the Lab color space. Here, the predetermined color is defined within the CIE color space, with a luminance L* of 85 or greater, and a* and b* that are each within the range of ±10. The CIE color space is a color space defined by the International Commission on Illumination. In a state where a toner image has not been formed, the amount of reflected light is large, and after a toner image has been formed, the amount of reflected light of complementary color component is smaller, depending on the density of each color. The density detection sensor 80 is a color sensor for three colors that is sensitive to red (R), green (G), and blue (B), and can detect the density of each color by reading a reference patch image of the complementary color components of each color. In the present embodiment, a reference patch of C (cyan) is read using a color sensor for red (R). Similarly, patches of M (magenta) and K (black) are read using the color sensor for green (G), and a reference patch for Y (yellow) is read using a color sensor for blue (B).

Density Detection Sensor

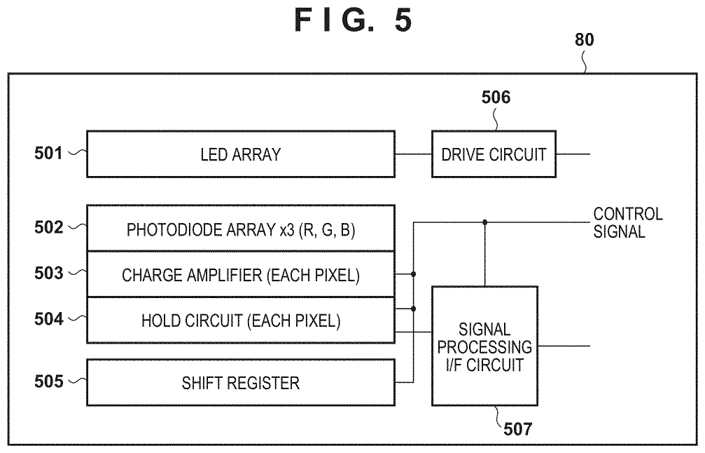

FIG. 5 is a diagram showing an example of an internal configuration of the density detection sensor 80 according to the present embodiment. An LED array 501 irradiates the surface of the intermediate transfer belt 2, and the light reflected therefrom is incident to three photodiode arrays 502. Each of the photodiode arrays 502 according to the present embodiment is constituted by pixels including 7700 photodiodes, and realizes a resolution of 600 dpi (dot per inch) for a paper size up to 304.8 mm in the horizontal scanning direction. Note that this configuration is an example, and the number of pixels and the resolution may be different. In the present embodiment, a constant amount of light is emitted when the patches for density correction are to be detected.

The three photodiode arrays 502 are respectively sensitive to red (R), green (G), and blue (B), and each receive light and convert it to an electric charge corresponding to the amount of light received. A charge amplifier 503 is connected to each pixel of the photodiode arrays 502, and charge is accumulated therein. The output voltage from each charge amplifier 503 changes in proportion to the amount of light that has entered thereto (the amount of received reflected light) in the accumulation time.

A hold circuit 504 is connected to the output of the charge amplifier 503, for each pixel. A hold pulse, which is one of the control signals from the CPU 201a, is input to the hold circuits 504 immediately before the charge amplifiers 503 are reset, and thus the outputs from the charge amplifiers 503 are held in the hold circuits 504 at the same time for every pixel. The reset operation for the charge amplifiers 503 is performed at the same time for every pixel. The time from when the reset switches (not shown) of the charge amplifiers 503 are turned OFF to when the hold pulse is input thereto is the charge accumulation time. In this way, the charge accumulation time is controlled so as to be a predetermined time stored in the RAM 201b, based on a control signal from the CPU 201a.

Thereafter, switches (not shown) connected to the outputs of the hold circuits 504 are turned ON in response to an address pulse from a shift register 505. As a result, signals held by the hold circuits 504 are sequentially output as time-series signals, and are output to the control unit 200 via a signal processing I/F circuit 507.

Density Table

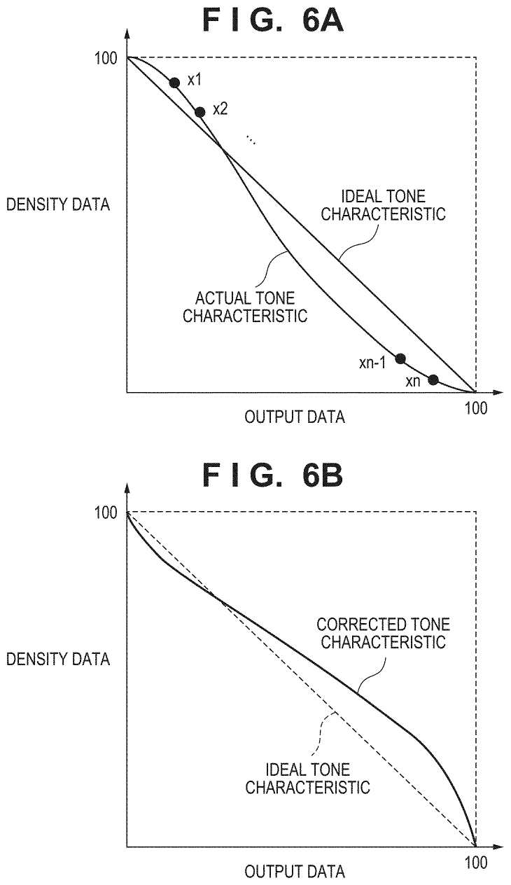

FIGS. 6A and 6B are diagrams illustrating a density table according to the present embodiment. In FIGS. 6A and 6B, the vertical axis indicates density data and the horizontal axis indicates output data. FIG. 6A shows a relationship between an actual tone characteristic and an ideal tone characteristic corresponding to data values. The CPU 201a creates, for each color, an actual tone characteristic graph corresponding to data values as an approximate curve based on the densities of the reference patches 98 read by the density detection sensor 80. Thereafter, the CPU 201a calculates a difference between the created approximate curve and the ideal tone characteristic. The CPU 201a creates a tone correction graph from the result of calculation of the difference, and rewrites the density table stored in the RAM 201b. This operation is performed for each color. FIG. 6B shows a relationship between the corrected tone characteristic and the ideal tone characteristic. This corresponds to the tone characteristic of the density data corrected based on the rewritten density table. Using this tone characteristic, the tone characteristic of the toner image to be formed is corrected so as to be similar to the ideal tone characteristic.

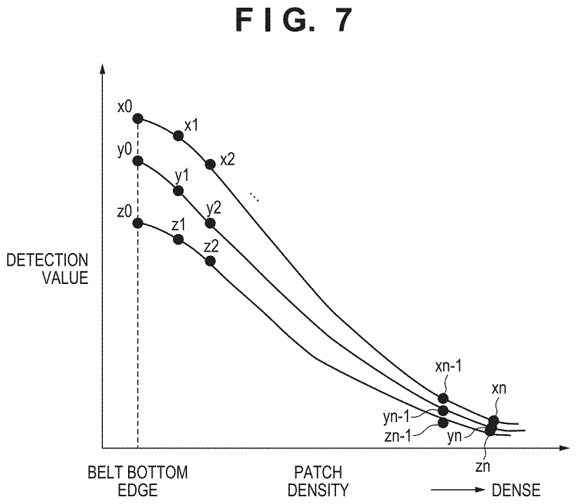

The following describes the fluctuation of the detection value caused by changes with time of the intermediate transfer belt 2. The color of the surface of the intermediate transfer belt 2 may change with time, from the color in the initial state (e.g. at the shipment of the product). In FIG. 7, the vertical axis indicates the detection value, and the horizontal axis indicates the patch density. The patch density increases to the right. As shown in FIG. 7, when the intermediate transfer belt 2 is in the initial state, the detection value of the belt surface is expressed as x0. As the color of the belt surface changes, the detection value changes to y0, z0, and so on even if patches with the same density are formed. That is to say, even if patches with the same density are formed, the detection value changes with time. Similarly, the detection values of reference patches with different densities formed on the intermediate transfer belt 2 change from x1, x2, . . . , xn−1, and xn to y1, y2, . . . , yn−1, and yn, and further to z1, z2, . . . , zn−1, and zn. As a result, the approximate curve of the tone characteristic derived therefrom also changes, and it becomes difficult to create a correct density table.

The easiest solution to the above-described situation is to equally add the difference between x0 and y0 or x0 and z0 to the detection values of the densities of the reference patches. However, as shown in FIG. 7, the slopes of the tone characteristic curves are different from each other, and it is impossible to match the curves with each other. The degree of effect of a change with time of the intermediate transfer belt 2 varies for each color. Therefore, it is impossible to perform uniform control.

Another method for improvement is to multiply the detection values of the densities of the reference patches by a coefficient that is based on a ratio between x0 and y0 or between x0 and z0. However, this method also amplifies error components and noise components included in the detection values. As a result, correction accuracy is degraded, and preferable results cannot be acquired.

Yet another method for improvement is to change the amount of light emitted from the LED array 501 of the density detection sensor 80 according to a change in the detection value of the belt surface. However, this method increases power consumption of the device, and shortens the lifespan of the LED array 501.

Therefore, the present embodiment is configured to achieve improvement by changing the charge accumulation times of the density detection sensor 80 according to a change in the detection value of the belt surface. The method according to the present embodiment realizes accurate density correction without causing the situations that are caused by other methods as described above.

Patch Configuration

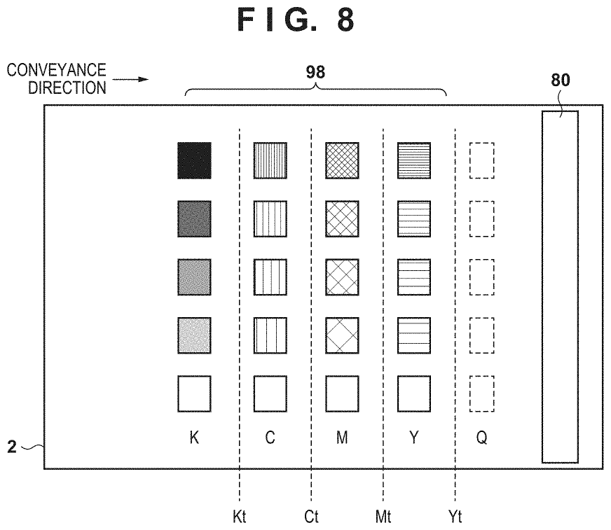

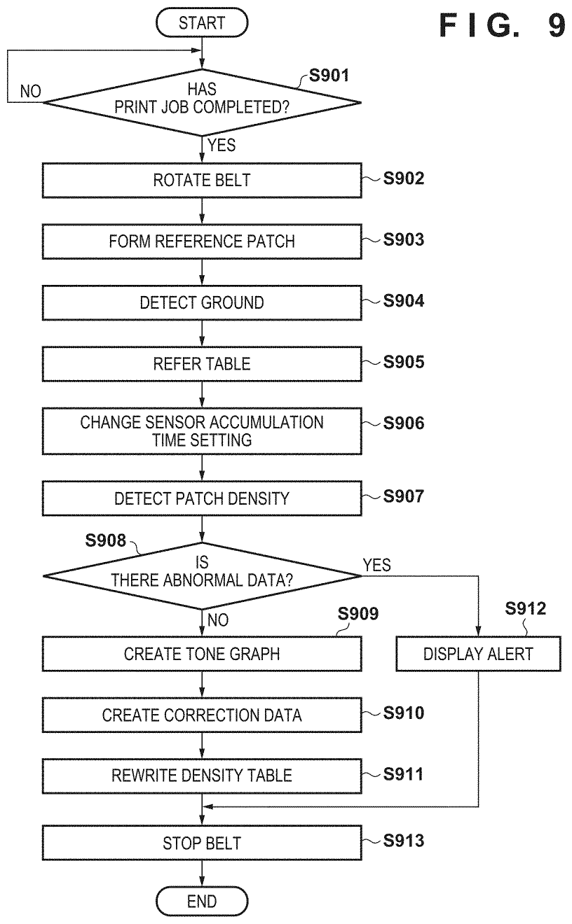

FIG. 8 is a schematic diagram of reference patches formed on the intermediate transfer belt 2 according to the present embodiment. In the present embodiment, the reference patches 98 are used as density correction patches for image formation. FIG. 8 is a diagram showing the intermediate transfer unit 20 seen from below (from the image forming unit 1 side). FIG. 8 shows examples of reference patch 98 formed on the surface of the intermediate transfer belt 2 when density correction operation is to be performed. In this case, a plurality of patches with different densities are arranged in the horizontal scanning direction. In the vertical scanning direction (the conveyance direction), the patches are arranged in the order of Y (yellow), M (magenta), C (cyan), and K (black). In other words, patches of toner of the respective colors are arranged in parallel in the vertical scanning direction. Note that the colors and arrangement of patches and the levels of densities of the patches (five levels of densities in this case) are examples, and the aspect of the embodiments is not limited to these examples. Also, in the present embodiment, the shapes, sizes, and intervals of the patches of the respective colors constituting the reference patches 98 are the same.

In the figure, the area indicated by Q from which the color of the ground of the intermediate transfer belt 2 is to be scanned. Scanning is performed on this area Q before the reference patches 98 are scanned. In the present embodiment, the number of areas Q to be scanned is determined in correspondence with the number of levels of the reference patches 98.

The broken lines indicated by Yt, Mt, Ct, and Kt in the figure virtually express points in time at which the settings of the charge accumulation times of the density detection sensor 80 are to be changed. In the present embodiment, the charge accumulation times of the density detection sensor 80 are determined based on the result of scanning of the ground (the area Q) of the intermediate transfer belt 2.

Also, as shown in FIG. 8, in the present embodiment, a plurality of patches of the same color with different levels of densities are arranged in the horizontal scanning direction. This is for the purpose of using only one charge accumulation time to perform measurement regarding one color, thereby reducing the number of times switching between charge accumulation times is performed. As a result, it is possible to perform measurement regarding the reference patches using a simpler algorithm than in the case of a configuration with which reference patches of different colors are formed in the horizontal scanning direction.

Processing Flow

The following describes a density correction operation according to the present embodiment with reference to FIG. 9. FIG. 9 is a flowchart of the density correction operation according to the present embodiment. The density correction operation is performed when a print job is complete. However, the timing of performing the density correction operation is not limited to when a print job is complete, and the density correction operation may be performed at a different time such as when an instruction is made by a user, when a predetermined period of time has elapsed from the previous print operation, and so on. In the present embodiment, the density correction operation is realized by the CPU 201a reading out and executing a program stored in the ROM 201c, thereby controlling various units.

In step S901, the CPU 201a determines whether or not a print job is complete. Upon determining that the print job is complete (YES in step S901), the CPU 201a proceeds to step S902.

In step S902, the CPU 201a rotates the intermediate transfer belt 2 so as to move in the conveyance direction. Here, the intermediate transfer belt 2 may be kept rotating without being stopped when the previous print job has been completed.

In step S903, the CPU 201a forms predetermined reference patches 98 on the intermediate transfer belt 2, using the image forming unit 1. In the present embodiment, the reference patches 98 to be formed are configured as shown in FIG. 8.

In step S904, the CPU 201a detects the density of the color of the ground of the intermediate transfer belt 2 on which the reference patches 98 have not been formed, using the density detection sensor 80. The position of the ground detected at this time is the area Q shown in FIG. 8.

In step S905, the CPU 201a refers to a setting value table stored in the ROM 201c, and determines, for each color, the value of the charge accumulation time corresponding to the density detection value of the ground of the intermediate transfer belt 2.

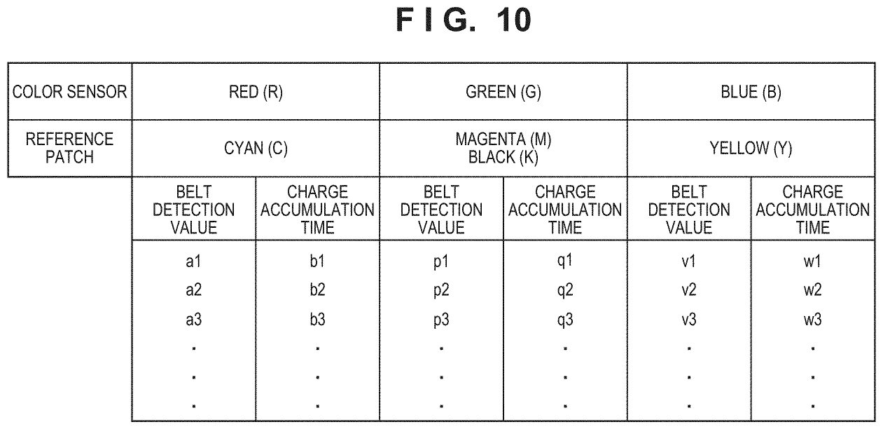

FIG. 10 is a diagram showing an example of a configuration of a setting value table according to the present embodiment. As described above, in the present embodiment, the sensor for the color red included in the photodiode arrays 502 of the density detection sensor 80 detects the density of cyan patches included in the reference patches 98. Similarly, the sensor for the color green detects the density of magenta and black patches included in the reference patches 98, and the sensor for the color blue detects the density of yellow patches included in the reference patches 98. The setting value table defines the charge accumulation times of the photodiode arrays 502 for each color of the reference patches 98 in correspondence with the detection values of the ground. The charge accumulation times corresponding to the belt detection values can be calculated from, for example, initial values of the intermediate transfer belt 2 (without deterioration) and detection values, based on coefficients calculated such that that the detection values will be the initial values. Although the present embodiment describes an example in which a predefined table is used, the charge accumulation time may be calculated for each color when density correction processing is to be performed, using the above-described formula.

For example, if the density detection value of the intermediate transfer belt 2 detected by the color sensor for red included in the density detection sensor 80 is a1, the charge accumulation time is determined to be b1. Similarly, if the density detection value of the intermediate transfer belt 2 is a2, the charge accumulation time is determined to be b2. At this time, relationships a1>a2 and b1<b2 are satisfied. Also, a1>a2>a3 and b1<b2<b3 are satisfied. The other colors have similar relationships. In the example shown in FIG. 10, the detection times of the intermediate transfer belt 2 and the charge accumulation times are associated with each other in one-to-one correspondence. However, the detection values may be defined as ranges.

In step S906, the CPU 201a changes the setting values of the density detection sensor 80 to the charge accumulation times for the respective colors determined in step S905. The settings of the charge accumulation times are changed in the timing for the detection target colors, namely at Kt, Ct, Mt, and Yt shown in FIG. 8, while the reference patches 98 are scanned.

In step S907, the CPU 201a detects the densities of the reference patches 98, using the density detection sensor 80. That is to say, the photodiode arrays 502 corresponding to the respective colors accumulate charges corresponding to the charge accumulation times that have been set, and outputs detection values of the respective colors according to the amounts of received light.

In step S908, the CPU 201a determines whether or not any of the values detected in step S907 is an abnormal value that is outside a predetermined range. Here, the predetermined range is defined in advance for each color and is stored in the ROM 201c, for example. If it is determined that a patch of any of the colors has abnormal data (YES in step), the CPU 201a proceeds to step S912, and if it is determined that none of the values have abnormal data (NO in step S908), the CPU 201a proceeds to step S909.

If it is determined that all of the detection values of the reference patches are included within a predetermined range, the CPU 201a creates a tone graph for each color in step S909. These graphs correspond to the tone characteristic of the curve shown in FIG. 6A.

In step S910, the CPU 201a creates correction data from the results of the creation performed in step S908.

In step S911, the CPU 201a rewrites the density table stored in the RAM 201b, using the correction data created in step S910. Thereafter, the CPU 201a proceeds to step S913.

If any of the colors have abnormal data, the CPU 201a displays, in step S912, warning information indicating that density correction has not been performed, on the operation unit 202, without reflecting the current detection values to the settings. At this time, information regarding the color from which abnormal data has been detected may be indicated together. Thereafter, the CPU 201a proceeds to step S913.

In step S913, the CPU 201a stops the intermediate transfer belt 2. Thereafter, the CPU 201a terminates this processing flow.

Using the density table rewritten in step S911, it is possible to obtain the corrected tone characteristic shown in FIG. 6B, which leads to an ideal tone characteristic for image formation.

As described above, with the present embodiment, the density of the color of the surface of the transfer member is detected when the density correction operation is to be performed, and the sensor charge accumulation times are changed according to the detected values. As a result, it is possible to accurately perform a density correction operation without being affected by a change in the color of the transfer member.

### Second Embodiment

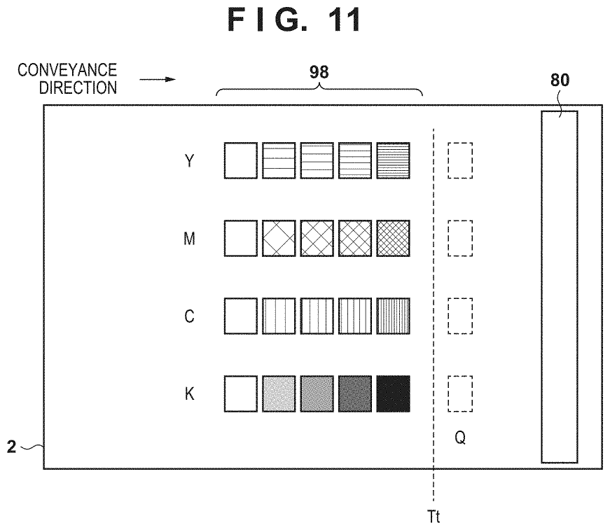

The following describes a second embodiment according to the disclosure. The present embodiment describes an example in which the pattern of the reference patches 98 used for a density correction operation is changed, with reference to FIG. 11. Note that descriptions of a configuration and the like that are the same as those in the first embodiment are omitted.

Patch Configuration

FIG. 11 is a schematic diagram of reference patches formed on the intermediate transfer belt 2 according to the present embodiment. FIG. 11 is a diagram showing the intermediate transfer unit 20 seen from below (from the image forming unit 1 side). When the charge accumulation times of the density detection sensor 80 can be individually set for each of the colors of the color sensors, the pattern of the reference patch 98 can be arranged as shown in FIG. 11. That is to say, in the present embodiment, the charge accumulation times of the density detection sensor 80 can be set for each position in the horizontal scanning direction. In this example, a plurality of reference patches with different densities are arranged in the vertical scanning direction such that patches are arranged for each of the colors Y (yellow), M (magenta), C (cyan), and K (black). Note that the colors and arrangement of patches and the levels of densities of the patches (five levels of densities in this case) are examples, and the aspect of the embodiments is not limited to them. Also, although the patches in this case are arranged such the densities thereof increase toward the downstream in the conveyance direction, the patches may be arranged in the opposite order.

In the figure, the area indicated by Q from which the basic color of the intermediate transfer belt 2 is to be scanned. Scanning is performed on this area Q before the reference patches 98 are scanned. The number of areas Q to be scanned is set according to the number of the colors of toner.

The broken lines indicated by Tt in the figure virtually express points in time at which the settings of the charge accumulation times of the density detection sensor 80 are to be changed. In the present embodiment, the charge accumulation times of the density detection sensor 80 are determined based on the result of scanning of the ground of the intermediate transfer belt 2. In the present embodiment, the settings of the individual colors of the color sensors of the density detection sensor 80 are made at the same time. With such configuration, it is possible to shorten the time required to perform the density correction operation.

The processing flow for density correction is the same as that shown in FIG. 9 described in the first embodiment.

As described above, with the present embodiment, the density of the color of the surface of the transfer member is detected when the density correction operation is to be performed, and the sensor charge accumulation times are changed according to the detected values. As a result, it is possible to accurately perform a density correction operation without being affected by a change in the color of the transfer member.

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-238648, filed Dec. 20, 2018, which is hereby incorporated by reference herein in its entirety.

What is claimed is:

1. An image forming apparatus that forms an image on a sheet, comprising:
an image forming unit configured to form the image;
a transfer member onto which the image is to be transferred;
a transfer unit configured to transfer the image formed on the transfer member onto the sheet;
a sensor configured to detect reflected light from a detection image on the transfer member based on a detection condition; and
a controller configured to:
control the sensor to detect an area of the transfer member in which the image is not formed;
generate the detection condition based on a result of detection of the area;
control the sensor to detect the detection image based on the detection condition; and
control a density of an image to be formed by the image forming unit, based on a result of detection of the detection image.

2. The image forming apparatus according to claim 1,
wherein, in a CIE color space, a color of a surface of the transfer member satisfies L*≥85, −10≤a*≤10, and −10≤b*≤10, where L* denotes a luminance.

3. The image forming apparatus according to claim 1,
wherein the sensor accumulates electric charge based on an amount of reflected light received from the detection image, and
the detection condition includes an accumulation time for which the electric charge is to be accumulated.

4. The image forming apparatus according to claim 1,
wherein the image forming apparatus executes image processing based on a conversion condition, and
the controller generates the conversion condition based on the result of detection of the detection image.

5. The image forming apparatus according to claim 1,
wherein the sensor includes a plurality of photodiodes.

6. The image forming apparatus according to claim 1,
wherein the controller generates the detection condition based on an initial result of detection of the area and the result of detection of the area.

7. The image forming apparatus according to claim 1,
wherein the transfer member conveys the detection image in a predetermined direction, and
the detection image includes detection images of different tones, arranged in a direction that is orthogonal to the predetermined direction.

8. The image forming apparatus according to claim 1,
wherein the sensor accumulates electric charge based on an amount of reflected light received from the detection image,
the detection condition includes an accumulation time for which the electric charge is to be accumulated,
the detection image includes detection images with different densities, and
the controller generates a plurality of accumulation times corresponding to the detection images based on the result of detection of the area.

9. The image forming apparatus according to claim 1,
wherein the sensor accumulates electric charge based on an amount of reflected light received from the detection image,
the detection condition includes an accumulation time for which the electric charge is to be accumulated, and
the controller increases the accumulation time based on a difference between the color of the area and a reference color.
